(19) United States
(12) Patent Application Publication
(10) Pub. No.: US 2011/0021280 A1
(43) Pub. Date: Jan. 27, 2011

(54) HITTING TECHNIQUE BY IDENTIFYING BALL IMPACT POINTS

(76) Inventors: Vladimir Boroda, Ashdod (IL); Igor Friedland, Shoham (IL)

Correspondence Address: The Law Office of Michael E. Kondoudis, 888 16th Street, N.W., Suite 800, Washington, DC, 20006, US

(21) Appl. No.: 12/509,527

(22) Filed: Jul. 27, 2009

(51) Int. Cl. A63B 69/36; A63B 69/38; G06F 19/00

(52) U.S. Cl. 473/220; 473/463; 473/223; 700/91

(57) ABSTRACT

A sensor system for identifying an impact point of a ball hitting a ball hitting means, and a system and method for improving a hitting technique based thereupon. One system comprises an optical array, an motion processing module, a processing unit and an interface unit. The optical array is attached to the ball hitting means and comprises light emitters and light detectors arranged to repeatedly determine consequent impact points of the ball by detecting reflections of emitted optical signals. The motion processing module is attached to the ball hitting means measures its motion characteristics. The processing unit is arranged to analyze and process the consequent impact points and the motion characteristics of the ball hitting means to characterized the hitting technique. The interface unit is arranged to present the hitting technique, generate suggestions for improving the hitting technique and allow further analysis of the hitting technique.

### BACKGROUND

1. Technical Field

The present invention relates to the field of training systems, and more particularly, to training systems for games involving hitting a ball.

2. Discussion of Related Art

One of the hallmarks of a good coach is the ability to evaluate tennis technique and prescribe actions that ultimately help a player improve. The technical term is qualitative analysis or using an everyday terminology—stroke analysis. It should be clear that such analysis has to be done systematically during a long period of time. This and only this monitoring can reflect an objective progress in learning process. In the past, the stroke analysis was limited to visually detecting stroke errors and providing corrections simply from playing the game. It was impossible to collect this information for more detailed study. This simplified training approach was explained by the absence of appropriate technological equipments.

Another situation takes place in present. It is known a large number of electronic systems that are targeting for coaching, training and analysis in tennis. Especially in the last 10-15 years a plurality of such systems (from simple movement sensory attachments to very complex visual motion analysis systems) was patented and developed. The majority of the systems use special high speed video cameras providing a video feedback. Motion analysis software is used to perform a 3D motion processing to measure speeds, accelerations, directions of racquet and ball during a game. However, special high speed cameras have to record up to 500 full video frames per second (for comparison, a standard PAL/NTSC video camera works at 25/30 frames per second) and are characterized by extremely high prices. In general, the system includes two or three cameras. Further, fast video acquisition electronics are used in order to grab a video data in real time. The latter also increases the overall system price. Then a huge amount of video information is processing off-line by special motion analysis software that extracts from the video information all required mechanical parameter of the racquet movement and the moment of its interaction with a ball. To summarize, prior art solutions suffer from at least one of the following disadvantages: low efficiency due to mechanical implementation, lack of feedback, lack of data collection. Even expensive systems lack the ability to produce immediate feedback and must rely of complex image processing procedures.

The following U.S. Patents are incorporated herein by reference in their entirety: U.S. Pat. No. 4,535,986 disclosing an inclination signaling device on a tennis racquet; U.S. Pat. No. 7,219,033 disclosing a single/multiple axes six degrees of freedom inertial motion capture system with initial orientation determination capability; U.S. Pat. No. 7,021,140 disclosing an electronic measurement of the motion of a moving body of sports equipment; U.S. Pat. No. 7,094,164 disclosing a trajectory detection and feedback system; and U.S. Pat. No. 7,199,798 disclosing a Method and device for describing video content.

The following patents and patent applications are incorporated herein by reference in their entirety: European Patent Document No. EP0697228 discloses an article for the play of tennis; WIPO Patent Document No. WO2004067099 discloses an interactive method and apparatus for tracking and analyzing a golf swing in a limited space with swing position recognition and reinforcement; WIPO Patent Document No. WO2004058364 discloses an evaluation device and vibration damper for a racket; European Patent Document No. EP0859942 discloses a device for measuring at least one physical parameter relating to a propelled game ball; U.S. Pat. No. 5,757,266 discloses an electronic apparatus for providing player performance feedback; U.S. Pat. No. 5,031,909 discloses an electronic athletic equipment; U.S. Pat. No. 4,822,042 discloses an electronic athletic equipment; U.S. Patent Publication No. US2004077438 discloses a racket orientation indicator device and associated method of operation; WIPO Patent Document No. WO2006004908 discloses a real-time measurements for establishing database of sporting apparatus motion and impact parameters; U.S. Patent Publication No. US2005239583 discloses a method for measuring parameters and a striking device; U.S. Patent Publication No. US2004014531 discloses a device for training the correct swing for a club; WIPO Patent Document No. WO2005118086 discloses a swing diagnosis device for use in ball game sports.

### BRIEF SUMMARY

Embodiments of the present invention provide a sensor system for identifying an impact point of a ball exhibiting a ball diameter, on at least one side of a ball hitting means. One sensor system comprises at least one transmitter, at least one detector and a control unit. The at least one transmitter is arranged to transmit an optical signal at a transmission timing. The at least one detector is arranged to detect a reflection of the optical signal from the ball, the reflection exhibiting a detection timing and detection intensity. The control unit is arranged to control the at least one transmitter; to control the at least one detector; to determine the transmission timing; and to analyze the reflection. The ball hitting means exhibits a hitting area comprising an edge, and a hitting volume defined by the hitting area, the ball diameter and the at least one side. The at least one transmitter is attached to at least one transmitting point on the edge; the at least one transmitter is arranged to transmit an optical signal to substantially the entire hitting volume; the at least one detector is attached to at least one detection point on the edge; and the at least one detector is arranged to detect the reflection of the ball hitting the ball hitting area at a part of substantially the entire hitting volume. The control unit is arranged to identify the impact point of the ball by analyzing the reflection timing in relation to the transmission timing and the at least one detection point.

Accordingly, according to an aspect of the present invention, there is provided a sensor system, wherein the at least one transmitter comprises a plurality of narrow angle light emitters, and the at least one detector comprises a single wide angle light detector.

Accordingly, according to another aspect of the present invention, there is provided a sensor system, wherein the at least one transmitter comprises a single wide angle light emitter, and the at least one detector comprises a plurality of narrow angle light detectors.

Embodiments of the present invention provide a system for improving a hitting technique of hitting a ball with a ball hitting means. One system comprises an optical array, motion processing module comprising at least one accelerometer and optionally a 3D Gyro, a processing unit and an interface unit. The optical array is attached to the ball hitting means and comprises at least one light emitter and at least one light detector arranged to repeatedly determine a plurality of consequent impact points of the ball on the ball hitting means by detecting at least one reflection of at least one emitted optical signal. The motion processing module is attached to the ball hitting means and arranged to measure motion characteristics of the ball hitting means. The processing unit is arranged to analyze and process the plurality of consequent impact points and the motion characteristics of the ball hitting means to characterize the hitting technique. The interface unit is arranged to present the hitting technique, generate suggestions for improving the hitting technique, communicate with remote processing computer allowing data collection and further analysis of the hitting technique.

Accordingly, according to an aspect of the present invention, there is provided a system further comprising a feedback module connected to the processing unit. The processing unit is further arranged to compare each of the plurality of consequent impact points to a predefined target impact point and generate a feedback notification relating to the comparison. The feedback module is arranged to generate an alert relating to the feedback notification.

Accordingly, according to another aspect of the present invention, there is provided a system further comprising a program editor comprising a GUI for defining a practice program and supervising its application in respect to the reports. The system is arranged to provide feedback regarding the hitting technique in view of the practice program.

Embodiments of the present invention provide a system for managing training of a group of players in a ball game comprising a plurality of measurement apparatuses for generating hitting data relating to the players' performance in hitting a ball with a ball hitting means. Each measurement apparatus comprises at least one position sensor, at least one motion processing module, a data acquisition module, performance feedback means and a communication module. The at least one position sensor is attached to the ball hitting means and arranged to repeatedly determine a plurality of consequent impact points of the ball on the ball hitting means. The motion processing module is attached to the ball hitting means and arranged to measure motion characteristics of the ball hitting means. The data acquisition module is arranged to analyze and process the plurality of consequent impact points and the motion characteristics of the ball hitting means and generate hitting data. The communication module is arranged to communicate the hitting data and the acquired data from the measurement apparatus via a first communication link. One system further comprises a server comprising a communication module, a control module and an interface module.

The communication module is connected via the first communication link to the communication modules of the plurality of measurement apparatuses. The communication module is further arranged to receive the hitting data from the communication modules. The communication module is further connected to a second communication link. The control module is arranged to receive and analyze the hitting data from the plurality of measurement apparatuses, and further arranged to generate reports relating to a hitting performance of each of the players and based on the analyzed data. The interface module arranged to present the hitting performance of each of the players and allow defining practice programs and supervising their application in respect to the reports.

Accordingly, according to an aspect of the present invention, there is provided a system, wherein the data acquisition module is arranged to identify the impact point of the ball by analyzing data relating to at least one of: reflection timing, reflection intensity, transmission timing, impact point, transmission point, detection point.

Embodiments of the present invention provide a method of identifying an impact point of a ball exhibiting a ball diameter, on at least one side of a ball hitting means exhibiting a hitting area comprising an edge and a hitting volume defined by the hitting area, the ball diameter and the at least one side. One method comprises: emitting at least one optical signal from the edge into substantially the entire hitting volume at a predefined timing; detecting at least one reflection exhibiting a detection timing and detection intensity, at the edge from substantially the entire hitting volume; and calculating the impact point from the detected reflections. The calculating utilizes at least differences between the predefined timing and the detection timing.

Accordingly, according to an aspect of the present invention, there is provided a method wherein the ball hitting means comprises at least one of: a racquet, a tennis racquet, a squash racquet, a club, a baseball bat, a golf club, a cricket bat.

Accordingly, according to another aspect of the present invention, there is provided a method, wherein the calculating the impact point from the detected reflections relates to at least one of: reflection timing; reflection intensity; emission timing; impact point; emission point; detection point; modulation of the optical signal; and modulation of the reflections.

Embodiments of the present invention provide a method of improving a hitting technique of a player hitting a ball with a ball hitting means. One method comprises: repeatedly identifying an impact point of a ball exhibiting a ball diameter, on at least one side of a ball hitting means exhibiting a hitting area comprising an edge and a hitting volume defined by the hitting area, the ball diameter and the at least one side. The identifying comprises: emitting at least one optical signal from the edge into substantially the entire hitting volume at a predefined timing; detecting at least one reflection exhibiting a detection timing and detection intensity, at the edge from substantially the entire hitting volume; and calculating the impact point from the detected reflections, wherein the calculating utilizes at least differences between the predefined timing and the detection timing. The method further comprises: measuring accelerations of the ball hitting means; analyzing the repeatedly identified impact points and the measured accelerations; and presenting a hitting performance report based on the analysis.

Accordingly, according to an aspect of the present invention, there is provided a method further comprising defining a practice program and repeatedly comparing the hitting performance report to the practice program.

Embodiments of the present invention provide a system, wherein the data acquisition module is arranged to identify the ball and the hitting means velocities before and after the impact moment by analyzing data relating to at least one of: reflection timing, reflection intensity, transmission timing, impact point, transmission point, detection point and motion processing modules data.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1A, 1B and 1C are high level schematic illustrations of a sensor system for identifying an impact point of a ball on a ball hitting means, velocities of ball and hitting means a hitting time, as well as a trajectory of hitting means during a hitting process, according to some embodiments of the invention;

FIGS. 2A, 2B and 2C are high level schematic illustrations of transmission and detection regions on ball hitting means, according to some embodiments of the invention. In this example, ball hitting means is a racquet;

FIGS. 3A, 3B, 3C, and 3D illustrate schematically impact detection carried out by transmitter emitting two optical signals, according to some embodiments of the invention;

FIG. 4 illustrates schematically impact detection carried out by transmitter 110 emitting two optical signals, according to some embodiments of the invention;

FIG. 5 is a high level block diagram illustrating a system for improving a hitting technique of hitting a ball with a ball hitting means, according to some embodiments of the invention;

FIG. 6 is a high level block diagram illustrating a system for managing training of a group of players in a ball game, according to some embodiments of the invention; and

FIGS. 7 and 8 are high level illustrative flowcharts of a method of improving a hitting technique of a player hitting a ball with a ball hitting means, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

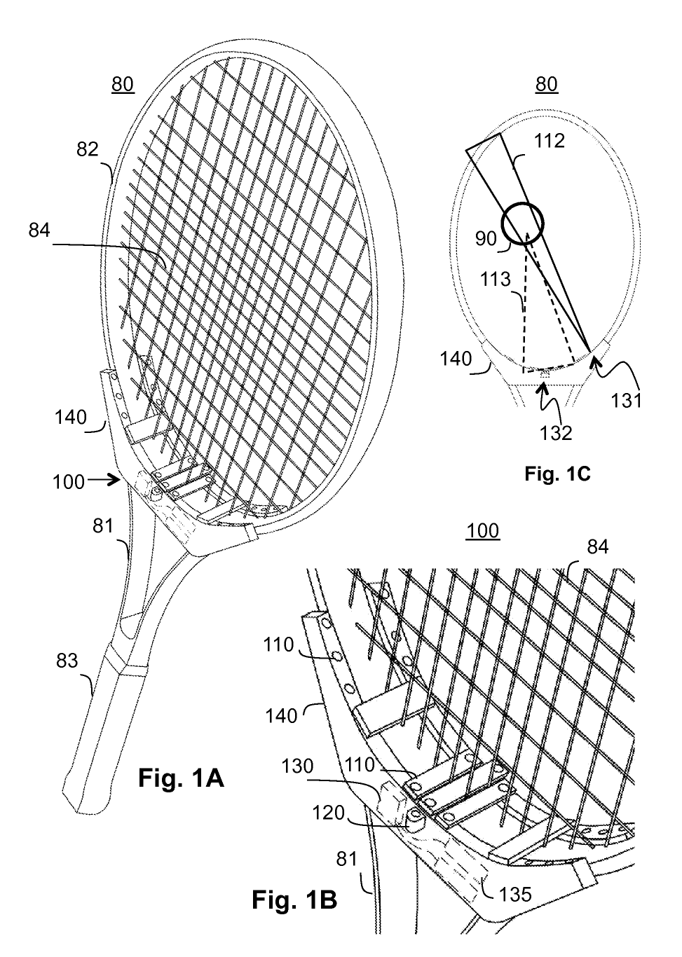

FIGS. 1A, 1B and 1C are high level schematic illustrations of a sensor system 100 for identifying an impact point of a ball 90 on a ball hitting means 80, velocities of ball 90 and hitting means 80 a hitting time, as well as a trajectory of hitting means 80 during a hitting process, according to some embodiments of the invention. Ball hitting means 80 exhibits a ball hitting area. In this example ball hitting means 80 is a racquet (FIG. 1A), which comprises a network of cords 84 stretched upon a hoop 82, a throat 81 and a handle 83. In this example ball hitting area comprises one or both sides of network of cords 84. FIG. 1B is a magnified section of FIG. 1A illustrating sensor system 100. FIG. 1C is a schematic illustration of an optical signal 112 transmitted from a transmitting point 131 onto ball 90 and a reflection 113 reflected towards a detection point 132 in an optical array 140. Network of cords 84 is not shown in FIG. 1C for convenience. Optical signal 112 may be interpreted as an optical beam.

Sensor system 100 comprises optical array 140 comprising at least one transmitter 110 (e.g., light emitting diodes LEDs, or laser diodes) and at least one detector 120 (e.g., a photo detector such as a photodiode). Transmitters 110 and detectors 120 may be arranged according to various schemes. They may be situated in one or both sides of a racquet-like ball hitting means 80, on one side or around the circumference of a club-like ball hitting means 80.

Transmitters 110 are arranged to transmit optical signals 112 at a transmission timing. Detectors 120 are arranged to detect reflection 113 of optical signal 112 from ball 90. For example a detection timing and a detection intensity may be measured for each reflection 113. Additionally, a direction from which reflection 113 is detected may be recorded. Optical signal 112 may be modulated in various ways, such as to allow identifying the source of each reflection 113. Modulation data of reflection 113 may be further analyzed.

Transmitters 110 may be attached to transmitting points 131 on the edge or circumference of the ball hitting area. Transmitters 110 are arranged to transmit optical signal 112 to substantially the entire hitting volume (defined by one ball diameter over the ball hitting area). Detectors 120 are attached to detection points 132 on the edge or circumference of the ball hitting area. Detectors 120 are arranged to detect reflections 113 of optical signal 112 from ball 90 hitting the ball hitting area at substantially the entire hitting volume.

According to some embodiments of the invention, optical array 140 may comprise one transmitter 110 and several detectors 120, for example one wide angle transmitter covering most of the hitting area of ball hitting means 80, and several narrow angle detectors allowing localization of reflections 113, and together cover most hitting area. Detectors 120 may be situated at the periphery of the ball hitting area, for example around network of cords 84 of a racquet. Optical array 140 may take a large or a small part of the circumference of the hitting area. Detecting reflections 113 from various locations allows measuring various hitting data and analyze the impact area and parameters. The combination between the detections of detectors 120 defines the impact point of ball 90 on the hitting surface 84.

According to some embodiments of the invention, optical array 140 may comprise several transmitters 110 and one detector 120, for example several narrow angle transmitters allowing transmitting light to predefined portions of the ball hitting area, and together cover most hitting area, and one wide angle detector covering most of the hitting area of ball hitting means 80. Each transmitter 110 may irradiate in sequence or simultaneously two optical signals 112 that intersect the point located above the racquet surface. Optical signals 112 may be modulated to allow a better differentiation between them at detector 120. If ball 90 hits at the intersection point, detector 120 registers two reflections 113 and indicates the position of ball 90. Transmitters 110 may have series excitation with help of a generator and a digital multiplexer. Optical signal 112 may be used as a photodiode amplifier strobe signal to organize the synchronized detection and separation of photodiode voltages proportional to reflections 113. Transmitters 110 may transmit optical signal 112 that are characterized by differing parameters (such as frequency, of phase), which may be used to distinguish reflections 113 of different optical signals 112. Optical signals 112 may be generated using a frequency synthesizer and a multiplexer.

According to some embodiments of the invention, optical array 140 may comprise a combination of narrow angle and wide angle transmitters and detectors arranged to optimally cover predefined regions of the ball hitting area. For example, in one embodiment, optical array 140 comprises nine narrow angle (±4°) transmitters and three wide view angle (±15°) detectors configured to cover most ball hitting area and in particular to cover the center of the ball hitting area with multiple transmitters 110. In one embodiment, four transmitters 110 cover the center, and one detector 120 cover the center in the middle of its detection range, while the other two detectors cover the center of the ball hitting area at the margin of their detection areas.

According to some embodiments of the invention, the ball hitting area may dissected into various detection regions, the optical array 140 is arranged to cover, allow detection, and allow distinguishing among hits in the various detection arrays. Each detection regions may be associated with transmitters 110 and detectors 120 configured to cover the detection region.

Sensor system 100 may further comprise a power source 135 and a control unit 130 arranged to control transmitters 110 (e.g., and to determine the transmission timing), to control detectors 120, and to analyze the reflection characteristics. Control unit 130 may be arranged to identify the impact point of ball 90 by analyzing the reflection timing in relation to the transmission timing, detection points 132 and transmission points 131. Control unit 130 may be arranged to identify the impact point of ball 90 by further analyzing any of the following: the reflection intensity, transmission points 131, detection points 132, optical signal characteristics, such as direction, intensity, incoming and outgoing angles and signal width, signal modulation and further characteristics of reflection 113.

According to some embodiments of the invention, sensor system 100 may be attached to ball hitting means 80 such that it influences minimally the performance of a player using ball hitting means 80. For example, in a racquet, the center of mass of sensor system 100 and the center of mass of the racquet may substantially coincide. For example, sensor system 100 may be attached to throat 81 of the racquet.

According to some embodiments of the invention, ball hitting means 80 may comprise a racquet such as a tennis racquet or a squash racquet, or a club, such as a baseball bat, a golf club, or a cricket bat.

According to some embodiments of the invention, ball hitting means 80 comprises a club comprising a handle and a hitting area exhibiting a circumference. Sensor system 100 may be attached at the circumference and arranged to transmit optical signals 112 and detect reflections 113 from at least a part of the circumference.

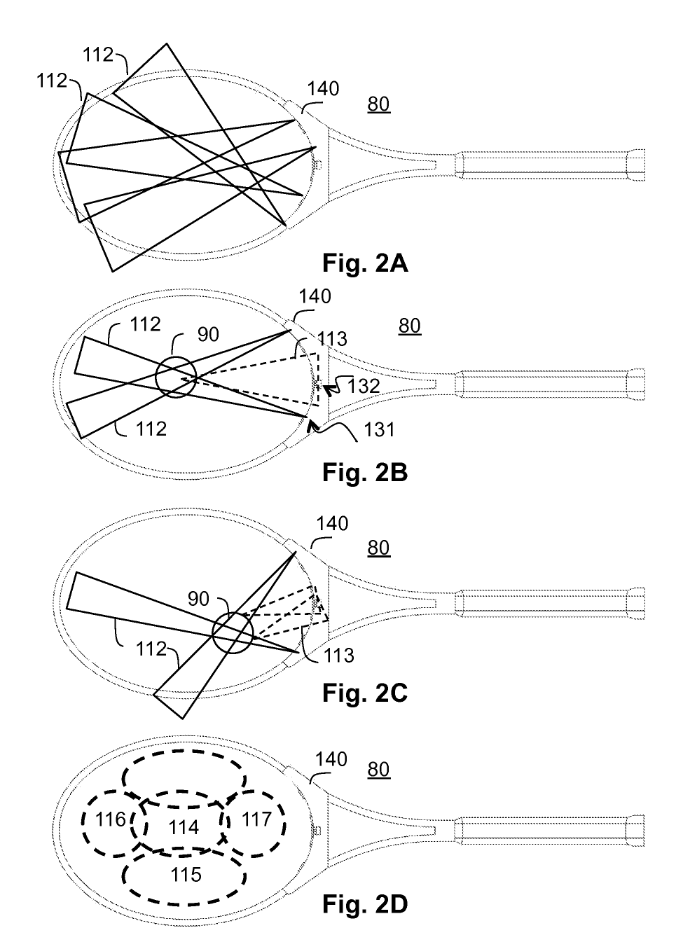

FIGS. 2A, 2B and 2C are high level schematic illustrations of transmission and detection regions on ball hitting means 80, according to some embodiments of the invention. In this example, ball hitting means 80 is a racquet. FIG. 2A illustrates a dissection of the ball hitting area into various detection regions, each with a designated optical signal 112. Transmitters 120 are arranged to provide maximal coverage of the center of the ball hitting area. FIG. 2B illustrating detection of ball 90 in the center of the ball hitting area. Two optical signals 112 are transmitted from two different transmission points 131, and their reflections 113 are detected at detection point 132. FIG. 2C illustrating detection of ball 90 in the margin of the ball hitting area. Two optical signals 112 are transmitted from two different transmission points 131, and their reflections 113 are detected at detection point 132. The location of ball 90 is calculated from reflections 113 and their characteristics. FIG. 2D is an illustration of various detection regions 114, 115, 116, 117 selected on the ball hitting area, and used to configure optical array 140. In this example the following detection regions are distinguished: a center 114 (also termed the sweet spot), a distal region 116, a proximal region 117 and sides 115.

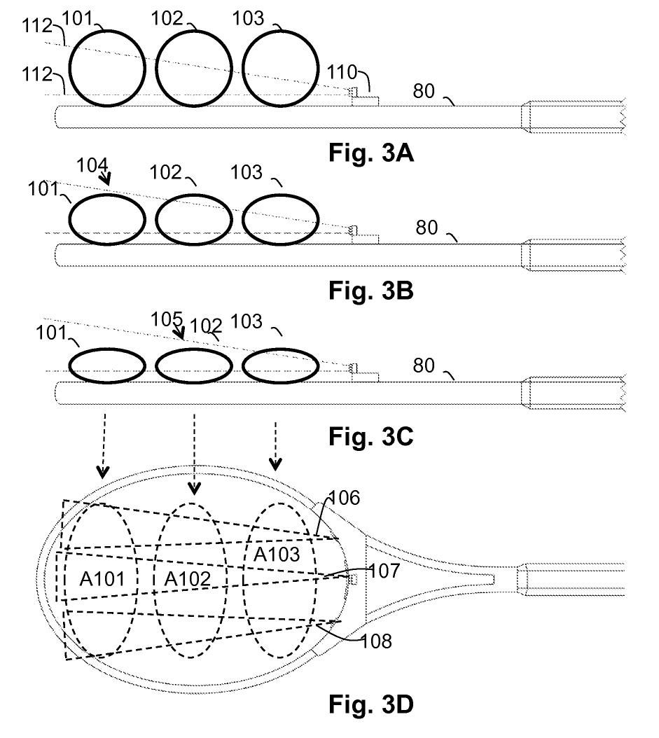

FIGS. 3A, 3B, 3C, and 3D illustrate schematically impact detection carried out by transmitter 110 emitting two optical signals 112, according to some embodiments of the invention. Additionally, this optical scheme is a part of embodiment to identify ball velocities and the velocities of ball hitting means 80 during the hitting time. FIGS. 3A, 3B, and 3C present three balls 101, 102, 103 during the first half of an impact upon ball hitting means 80. Ball 102 hits ball hitting means 80 at the center 102A (also termed the sweet spot) of the hitting area (illustrated in FIG. 3D), ball 101 hits ball hitting means 80 at a distal area 101A (in relation to center 102A) of the hitting area, and ball 103 hits ball hitting means 80 at a proximal area 103A (in relation to center 102A) of the hitting area. Three balls 101, 102, 103 do not hit ball hitting means 80 simultaneously of course, yet are drawn together for explanatory reasons. Transmitter 110 may comprise two narrow angle light emitters each sending an optical beam 112. The light beam of the lower emitter may be parallel to hitting area while the light beam of the upper emitter goes up creating so called double beam fork. The angle between two beams is selected in such manner to distinguish three different ball positions on the racquet (proximal 103A, center 102A and distal 101A, as shown in FIG. 3D). When ball 101 hits ball hitting means 80 first crosses the upper beam and then crosses the lower one, at different times. After the contact with ball hitting means 80, ball 101 is compressed and there is no reflection from the upper beam (past point 104. FIG. 3B) until ball 101 is bounced back and leaves ball hitting means 80. When ball 102 hits ball hitting means 80 on central part 102 it first crosses the upper beam, then still crossing the upper beam it crosses the lower beam. In its maximal compression point there is no reflection from the upper beam at point 105 (FIG. 3C). When ball 103 hits proximal part 103A of ball hitting means 80, it first crosses the upper beam, then it contacts the hitting area and crosses the lower beam. Staying compressed, ball 103 still crosses both beams (FIG. 3C). In these three positions the reflection 113 to detector 120 differs both in energy and in time. Thus, the three ball hitting areas 101A, 102B and 103A may be distinguished upon analyzing reflection data. According to some embodiments of the invention, several transmitters 110 (each emitting two optical signals) may be positioned and operated at several transmission points 106, 107, 108, and a similar analysis may allow distinguishing middle and lateral regions of distal region 101A, center 102A and proximal region 103A, thus allowing more exact data.

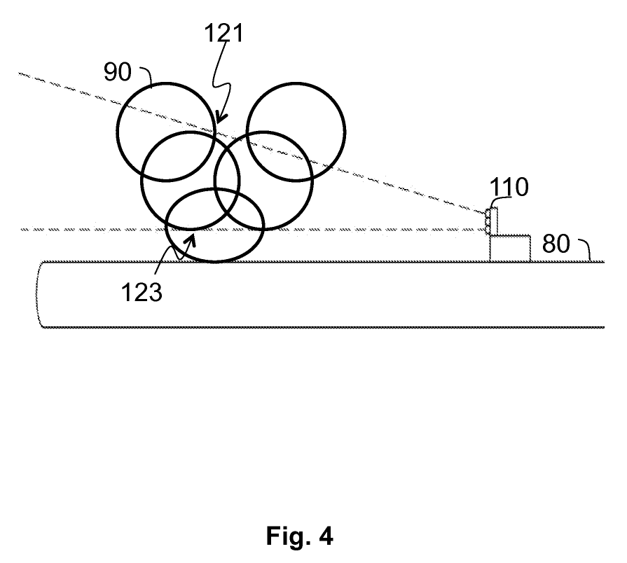

FIG. 4 illustrates schematically impact detection carried out by transmitter 110 emitting two optical signals, according to some embodiments of the invention. The two optical signals meet ball 90 bouncing off from ball hitting means 80, which may be in motion. In this example, as ball 90 approaches and recedes from ball hitting means 80, it cuts the upper beam, stops cutting the upper beam at point 121, cuts the lower beam at point 123, hits ball hitting means 80 and is being compressed. Detecting the reflections of the various beams allows calculating the speed of approach and the speed of leaving ball hitting means 80. Combined with a sensor measuring the velocities and accelerations of ball hitting means 80, the data allow calculating ball speed, acceleration and dwell time on ball hitting means 80.

According to some embodiments of the invention, the system as demonstrated in FIGS. 3A, 3B, 3C, and 3D and in FIG. 4, and applied to a racquet as ball hitting means 80, allows calculating ball and racquet velocities using some additional motion parameters (such the velocities of the ball and racquet at various stages before, at and after impact) and a number of known ball and racquet parameters, such as their masses and the racquet's COR (coefficient of restitution), which may be calculated by different methods. For example, assuming the impact is an elastic collision, the incoming and outgoing ball velocities may be calculated, The system calculates from the racquet's trajectory and speed during the impact and from the timing of the ball—racquet collision—the trajectory of the racquet before and after the ball impact, as well as the racquet and ball velocities. This set of parameters is a basis for analyzing the player technique performance.

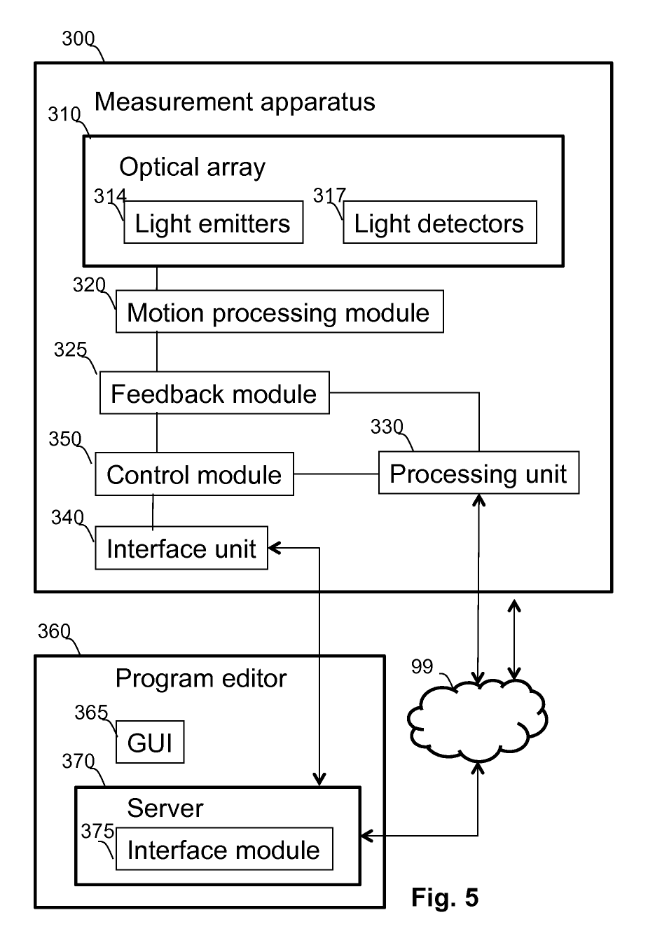

FIG. 5 is a high level block diagram illustrating a system for improving a hitting technique of hitting a ball with a ball hitting means, according to some embodiments of the invention. The system comprises a measurement apparatus 300. Measurement apparatus 300 comprises an optical array 310, a motion processing module 320 (e.g., an accelerometer and/or a gyroscope), a processing unit 330 and an interface unit 340.

According to some embodiments of the invention, optical array 310 is attached to the ball hitting means and comprising at least one light emitter 314 and at least one light detector 317 arranged to repeatedly determine a plurality of consequent impact points of the ball on the ball hitting means by detecting at least one reflection of at least one emitted optical signal. Motion processing module 320, comprises, e.g., a 3-axis solid state accelerometer, a gyroscope, or their combination. Motion processing module 320 is attached to the ball hitting means and arranged to measure motion characteristics of the ball hitting means. Motion characteristics may comprise the trajectory of movement, speed and acceleration of the ball hitting means. Processing unit 330 is arranged to analyze and process the plurality of consequent impact points and the motion characteristics of the ball hitting means to characterize the hitting technique. Interface unit 340 is arranged to present the hitting technique, generate suggestions for improving the hitting technique, communicate with remote processing computer and allowing data collection and further analysis of the hitting technique. Interface unit 340 may be part of measurement apparatus 300 or be connected to measurement apparatus 300 directly or via a communication link.

According to some embodiments of the invention, the system may further comprise a feedback module 325 connected to processing unit 330. Processing unit 330 is further arranged to compare each of the plurality of consequent impact points to a predefined target impact point and generate a feedback notification relating to the comparison. Feedback module 325 is arranged to generate an alert relating to the feedback notification. Feedback module 325 may be part of measurement apparatus 300. For example, the alert may notify the player of hitting the ball with a predefined area of the ball hitting means, e.g., the center or the periphery of a racquet, or predefined areas of a club. Feedback may comprise audio and/or visual alerts.

According to some embodiments of the invention, the system further comprises a program editor (implemented e.g. on a remote processing computer) comprising a GUI for defining a practice program and supervising its application in respect to the reports. The system is arranged to provide feedback regarding the hitting technique in view of the practice program.

According to some embodiments of the invention, the system further comprises a control module 350 arranged to receive and analyze the hitting technique data from interface unit 340, and further arranged to generate reports relating to the hitting technique. Interface unit 340 and control module 350 may be embodied either within measurement apparatus 300 or as a separate unit associated therewith.

Measurement apparatus 300 may be arranged to deliver hitting data comprising the location of the ball impact on the hitting area, dwell time of ball 90 at the hitting area, rhythm and number of impacts, type of stroke and level of spin, velocity of the incoming and outgoing ball as well as velocity of the ball hitting means before and after the ball impact. Measurement apparatus 300 may be further arranged to deliver hitting data comprising the trajectory parameters of the entire stroke.

According to some embodiments of the invention, the system further comprises a program editor 360 comprising a graphical user interface (GUI) 365 for defining a practice program and supervising its application in respect to the reports, wherein the system is arranged to provide feedback regarding the hitting technique in view of the practice program.

According to some embodiments of the invention, program editor 360 may further comprises a server 370 connected to control module 350 via a communication link 99 and comprising an interface module 375 allowing a trainer to define the practice program and supervise its application.

According to some embodiments of the invention, the system may comprise additional audio or visual means of enhancing measurement of hitting data and hitting technique parameters.

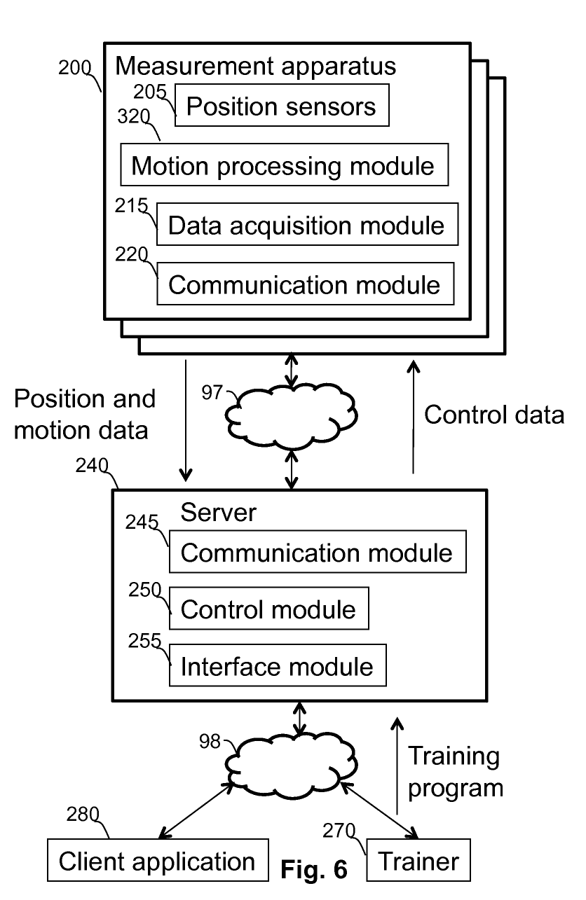

FIG. 6 is a high level block diagram illustrating a system for managing training of a group of players in a ball game, according to some embodiments of the invention. The system comprises a plurality of measurement apparatuses 200 for generating hitting data relating to the players' performance in hitting a ball with a ball hitting means. Each measurement apparatus 200 comprises at least one position sensor 205, at least one motion processing module 320, a data acquisition module 215, and a communication module 220. Position sensors 205 are attached to the ball hitting means and arranged to repeatedly determine a plurality of consequent impact points of the ball on the ball hitting means. Motion processing modules 320 are attached to the ball hitting means and arranged to measure motion characteristics of the ball hitting means. Data acquisition module 215 is arranged to analyze and process the plurality of consequent impact points and the motion characteristics of the ball hitting means and generate hitting data. Communication module 220 is arranged to communicate the hitting data and the acquired data (for example, position and motion data) from measurement apparatus 200 via a first communication link 97.

The system further comprises a server 240 comprising a communication module 245, a control module 250, and an interface module 255. Communication module 245 is connected via first communication link 97 to communication modules 220 of measurement apparatuses 200. Communication module 245 is further arranged to receive the hitting data from communication modules 220. Communication module 245 is connected to a second communication link 98. Control module 250 is arranged to receive and analyze the hitting data from measurement apparatuses 200, and further arranged to generate reports relating to a hitting performance of each of the players and based on the analyzed data. Control module 250 may be arranged to communicate various control data (such as calibration, data relating to practice programs, various criteria and parameters required to the analysis of position and motion data, feedback data, and so forth) to measurement apparatuses 200. Interface module 255 is arranged to present the hitting performance of each of the players and allow defining practice programs and supervising their application in respect to the reports.

According to some embodiments of the invention, data acquisition module 215 is arranged to identify the ball and the hitting means velocities before and after the impact moment by analyzing data relating to at least one of: reflection timing, reflection intensity, transmission timing, impact point, transmission point, detection point and motion processing modules data.

According to some embodiments of the invention, server 240 is further arranged to provide the players with feedback regarding their hitting performance in view of the practice programs. Feedback may be provided to the players via feedback modules associated with or integrated within measurement apparatus 200 or ball hitting means.

According to some embodiments of the invention, server 240 is connected via second communication link 98 to a client application 280 allowing a trainer 270 to supervise the training of the group of players. Client application 280 may be available to other players or to various web users, as well as to each player at a later time, and allow presenting various data relating to the hitting technique and performance. For example, a player may be allowed to define training aims and follow their accomplishment via client application 280. Trainer 270 may supervise the players via communication link 98.

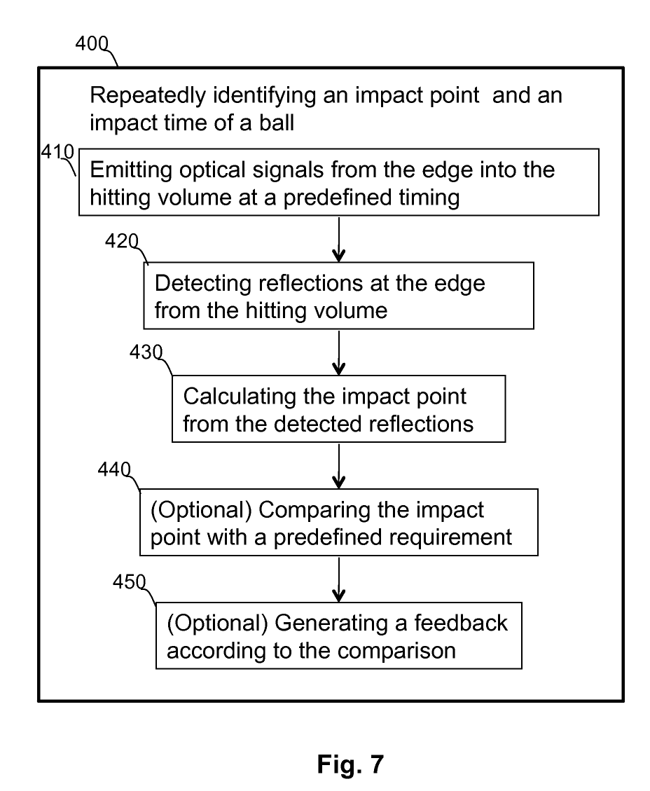

FIG. 7 is a high level illustrative flowchart of a method of identifying an impact point of a ball on at least one side of a ball hitting means, according to some embodiments of the invention. The ball exhibits a ball diameter, and the ball hitting means exhibits a hitting area comprising an edge and a hitting volume defined by the hitting area, the ball diameter and the sides (one or two) on which the method is carried out. The method comprises the stages: emitting at least one optical signal from the edge into substantially the entire hitting volume at a predefined timing (stage 410); detecting at least one reflection exhibiting a detection timing and detection intensity, at the edge from substantially the entire hitting volume (stage 420); and calculating the impact point from the detected reflections (stage 430). Calculating the impact point (stage 430) utilizes at least differences between the predefined timing and the detection timing.

According to some embodiments of the invention, the method may further comprise: comparing the impact point with a predefined requirement (stage 440); and generating a feedback (stage 440) relating to the comparison (stage 440) substantially immediately after calculating the impact point (stage 430).

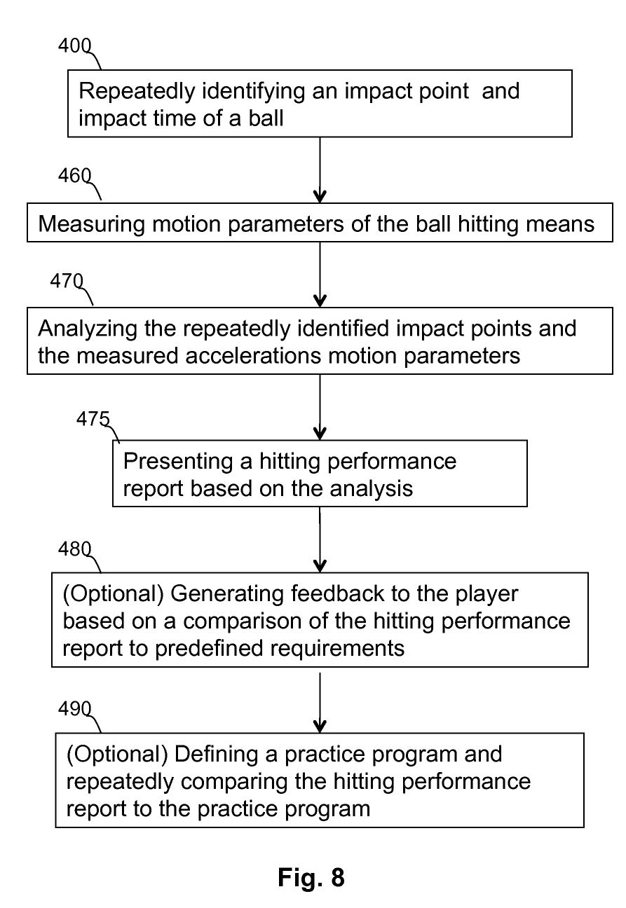

FIGS. 7 and 8 are high level illustrative flowcharts of a method of improving a hitting technique of a player hitting a ball with a ball hitting means, according to some embodiments of the invention. The method comprises repeatedly identifying an impact point and an impact time of the ball (stage 400). The ball exhibits a ball diameter, and the ball hitting means exhibits a hitting area comprising an edge and a hitting volume defined by the hitting area, the ball diameter and the sides (one or two) on which the method is carried out. repeatedly identifying a impact point and an impact time and an impact time of the ball (stage 400) comprises the stages: emitting at least one optical signal from the edge into substantially the entire hitting volume at a predefined timing (stage 410); detecting at least one reflection exhibiting a detection timing and detection intensity, at the edge from substantially the entire hitting volume (stage 420); and calculating the impact point from the detected reflections (stage 430). Calculating the impact point (stage 430) utilizes at least differences between the predefined timing and the detection timing.

The method of improving the hitting technique further comprises the stages: measuring motion parameters ( such as acceleration, speed, trajectory) of the ball hitting means (stage 460); analyzing the repeatedly identified impact points and the measured motion parameters (stage 470); and presenting a hitting performance report based on the analysis (stage 475).

According to some embodiments of the invention, the method may further comprise generating feedback to the player based on a comparison of the hitting performance report to predefined requirements (stage 480). Generating feedback (stage 480) may be carried out substantially immediately after each identification of the impact point (stage 400).

According to some embodiments of the invention, the method may further comprise defining a practice program and repeatedly comparing the hitting performance report to the practice program (stage 490).

According to some embodiments, this invention is a new method of detection of contact place of a ball 90 on a ball hitting means 80 (e.g. a tennis ball on a tennis racquet or a baseball on a bat) during the stroke performance, as well as a new method of measuring velocities of ball 90 and ball hitting means 80 prior and after the stroke performance, and finally a new method of a customization process for using ball hitting means 80. According to some embodiments, the invention comprises ball—racquet contact place sensor based on optical means and the synchronous detection method, ball—racquet velocities sensor based on the combination of optical sensors and motion processing modules, racquet movement sensor based on interaction between motion and optical sensors allowing to calculate the trajectory of the racquet swing, on-racquet player's interface and audible means for immediate performance feedback, wireless (e.g., RF) data link means to control, collect and analyze player's performance, and a backend computer for statistical performance processing and result storage as well as multi player control and management. The invention targets to: improve and stabilize a playing skills; reduce the potential for physical injury; customize the racquet according to individual needs. The invention may further applied to biomechanical applications for children playing activities and different physiotherapy devices.

According to some embodiments of the invention, the system comprises one or more tennis racquets and a remote control and processing unit. The racquet is equipped by an electronic means to collect the player's performance data such as a location of the ball impact on the racquet string surface, dwell time, rhythm and number of impacts, type of stroke and level of spin, velocity of the incoming and outgoing ball as well as velocity of the racquet before and after the ball impact. The trajectory parameters of the entire stroke are measured as well. Electronic means include a novel optical sensor for ball impact location detection, a novel optical sensor for the velocities measurement, motion processing modules, controller with memory, interface electronics, wireless communication, and battery. Audio/visual feedback means is a part of the electronic means of the racquet as well as a standalone remote control and processing unit that communicates with the racquet controller. When racquet is operated in a standalone mode there is no communication with a remote control and processing unit online. The predefined performance rules are loaded into the controller memory. During the game or training the performance data is collected and compared with the predefined performance parameters. Immediate audio/visual feedback is provided for the player corrective actions via a performance feedback means. The performance feedback means may provide the player the performance results according to the predefined playing practice. When racquet is operated in online communication mode the performance data collected by the racquet controller is transferred to remote control and processing unit after every stroke made by player. Immediate audio/visual feedback is provided for the player/coach corrective actions and the said data is stored for further performance analysis and statistic collection. The performance rules may be changed online depending on game or training conditions. Remote control and processing unit may operate one or more equipped tennis racquets in the same time allowing reliable performance monitoring of the group of players during training time. The collected performance data further may be used for player technique development evaluation, precise personal racquet customization and for early diagnostic and prevention of the different typical tennis injuries. The proposed system in its different configurations is intended for use by professional, recreational and beginner players as well.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A sensor system for identifying an impact point of a ball exhibiting a ball diameter, on at least one side of a ball hitting means, the sensor system comprising:
at least one transmitter arranged to transmit an optical signal at a transmission timing;
at least one detector arranged to detect a reflection of the optical signal from the ball, the reflection exhibiting a detection timing and detection intensity; and
a control unit arranged to control the at least one transmitter; to control the at least one detector; to determine the transmission timing; and to analyze the reflection,
wherein the ball hitting means exhibits a hitting area comprising an edge, and a hitting volume defined by the hitting area, the ball diameter and the at least one side,
wherein the at least one transmitter is attached to at least one transmitting point on the edge; the at least one transmitter is arranged to transmit an optical signal to substantially the entire hitting volume; the at least one detector is attached to at least one detection point on the edge; and the at least one detector is arranged to detect the reflection of the ball hitting the ball hitting area at a part of substantially the entire hitting volume, and
wherein the control unit is arranged to identify the impact point of the ball by analyzing the reflection timing in relation to the transmission timing and the at least one detection point.

2. The sensor system of claim 1, wherein the control unit is arranged to identify the impact point of the ball by further analyzing the reflection intensity.

3. The sensor system of claim 1, wherein the control unit is arranged to identify the impact point of the ball by further analyzing data relating to the at least one transmission point.

4. The sensor system of claim 1, wherein the at least one transmitter comprises a plurality of narrow angle light emitters, and the at least one detector comprises a single wide angle light detector.

5. The sensor system of claim 1, wherein the at least one transmitter comprises a single wide angle light emitter, and the at least one detector comprises a plurality of narrow angle light detectors.

6. The sensor system of claim 1, wherein the ball hitting means comprises a racquet comprising a throat and a center of mass, wherein the sensor system exhibits a center of mass, and wherein the sensor system is attached to the racquet at the throat, such that the center of mass of the sensor system and the center of mass of the racquet substantially coincide.

7. The sensor system of claim 6, wherein the racquet comprises one of: a tennis racquet, a squash racquet.

8. The sensor system of claim 1, wherein the ball hitting means comprises a club, the club comprising a handle and a hitting area exhibiting a circumference, wherein the sensor system is attached at the circumference, and wherein the at least one side of the ball hitting means comprises at least a part of the circumference.

9. The sensor system of claim 8, wherein the club comprises one of: a baseball bat, a golf club, a cricket bat.

10. The sensor system of claim 8, wherein the optical signal is modulated with a predefined modulation data, and the at least one detector is arranged to measure the hitting data utilizing modulation data in the reflection.

11. A system for improving a hitting technique of hitting a ball with a ball hitting means comprising:
an optical array attached to the ball hitting means and comprising at least one light emitter and at least one light detector arranged to repeatedly determine a plurality of consequent impact points of the ball on the ball hitting means by detecting at least one reflection of at least one emitted optical signal;
a motion processing module attached to the ball hitting means and arranged to measure motion characteristics of the ball hitting means;
a processing unit arranged to analyze and process the plurality of consequent impact points and the motion characteristics of the ball hitting means to characterized the hitting technique; and
an interface unit arranged to present the hitting technique, generate suggestions for improving the hitting technique and allow further analysis of the hitting technique.

12. The system of claim 11, wherein the motion processing module comprises at least one accelerometer and a 3D Gyro.

13. The system of claim 11, further comprising a feedback module connected to the processing unit, wherein the processing unit is further arranged to compare each of the plurality of consequent impact points to a predefined target impact point and generate a feedback notification relating to the comparison, and wherein the feedback module is arranged to generate an alert relating to the feedback notification.

14. The system of claim 11, further comprising a control module arranged to receive and analyze the hitting technique data from the interface unit, and further arranged to generate reports relating to the hitting technique.

15. The system of claim 13, further comprising a program editor comprising a GUI for defining a practice program and supervising its application in respect to the reports, wherein the system is arranged to provide feedback regarding the hitting technique in view of the practice program.

16. The system of claim 15, wherein the program editor further comprises a server connected to the control module via a communication link and comprising an interface module allowing a trainer to define the practice program and supervise its application.

17. The system of claim 11, wherein the ball hitting means comprises a racquet comprising a throat and a center of mass, wherein the system exhibits a center of mass, and wherein the system is attached to the racquet at the throat, such that the center of mass of the system and the center of mass of the racquet substantially coincide.

18. The system of claim 11, wherein the ball hitting means comprises a club, the club comprising a handle and a hitting area exhibiting a circumference, and wherein the system is attached at the circumference.

19. The system of claim 11, wherein the optical array comprises a plurality of narrow angle light emitters and a single wide angle light detector.

20. The system of claim 11, wherein the optical array comprises a single wide angle light emitter and a plurality of narrow angle light detectors.

21. The system of claim 11, wherein the emitted optical signal is modulated with a predefined modulation data, and the at least one light detector is arranged to measure the hitting data utilizing modulation data in the reflection.

22. A system for managing training of a group of players in a ball game comprising:
a plurality of measurement apparatuses for generating hitting data relating to the players' performance in hitting a ball with a ball hitting means, each measurement apparatus comprising:
at least one position sensor attached to the ball hitting means and arranged to repeatedly determine a plurality of consequent impact points of the ball on the ball hitting means;
at least one motion processing module attached to the ball hitting means and arranged to measure motion characteristics of the ball hitting means;
a data acquisition module arranged to analyze and process the plurality of consequent impact points and the motion characteristics of the ball hitting means and generate hitting data; and
a communication module arranged to communicate the hitting data and the acquired data from the measurement apparatus via a first communication link, and
a server comprising:
a communication module connected via the first communication link to the communication modules of the plurality of measurement apparatuses; arranged to receive the hitting data from the communication modules; and connected to a second communication link;
a control module arranged to receive and analyze the hitting data from the plurality of measurement apparatuses, and further arranged to generate reports relating to a hitting performance of each of the players and based on the analyzed data; and
an interface module arranged to present the hitting performance of each of the players and allow defining practice programs and supervising their application in respect to the reports.

23. The system of claim 22, wherein the motion processing module comprises at least one accelerometer and a 3D Gyro.

24. The system of claim 22, wherein the server is further arranged to provide the players with feedback regarding their hitting performance in view of the practice programs.

25. The system of claim 22, wherein the server is connected via the second communication link to a client application allowing a trainer to supervise the training of the group of players.

26. The system of claim 22, wherein the ball hitting means comprises a racquet comprising a throat and a center of mass, wherein the measurement apparatuses exhibit a center of mass, and wherein the measurement apparatuses are attached to the racquet at the throat, such that the center of mass of the measurement apparatus and the center of mass of the racquet substantially coincide.

27. The system of claim 22, wherein the ball hitting means comprises a club, the club comprising a handle and a hitting area exhibiting a circumference, and wherein the measurement apparatuses are attached at the circumference.

28. The system of claim 22, wherein the data acquisition module is arranged to identify the impact point of the ball by analyzing data relating to at least one of: reflection timing, reflection intensity, transmission timing, impact point, transmission point, detection point.

29. The system of claim 22, wherein each of the measurement apparatuses comprises a plurality of narrow angle light emitters, and a single wide angle light detector.

30. The system of claim 22, wherein each of the measurement apparatuses comprises a single wide angle light emitter, and a plurality of narrow angle light detectors.
